(19) United States
(12) Patent Application Publication
(10) Pub. No.: US 2003/0229675 A1
(43) Pub. Date: Dec. 11, 2003

(54) Effective garbage collection from a Web document distribution cache at a World Wide Web source site

(75) Inventors: Andrew Dunshea, Austin, TX (US); James Newman Chen, Austin, TX (US)

Correspondence Address: Mark E. McBurney, International Business Machines Corporation, Intl Prop Law Dept., Internal Zip 4054, 11400 Burnet Road, Austin, TX, 78758, US

(73) Assignee: International Business Machines Corporation, Armonk, NY

(21) Appl. No.: 10/165,082

(22) Filed: Jun. 6, 2002

(51) Int. Cl. G06F 15/167

(52) U.S. Cl. 709/212; 709/234; 709/219

(57) ABSTRACT

Protocols based upon recency of use of Web documents have, in the past, been relatively satisfactory in clearing of caches. However, the greatly accelerated use of the Web both in numbers of users and in the sizes of Web documents demands more effective processes for Web cache clearing. Accordingly, there is determined for each Web document in the cache, a retrieval hardship factor. Then, in the clearing of documents from the cache, this retrieval hardship factor will be used in combination with the recency of use protocols in determining which documents are to be cleared from the cache. The retrieval hardship factor may be effectively used in combination with either most recently used (MRU) or least recently used (LRU) cache garbage collection procedures. The hardship retrieval factor is preferably determined for each accessed and cached Web document by the owner or host of the Web site, i.e. the resource location or source database on the Web. At least the following three attributes are used in this determination of the hardship retrieval factor: the total CPU time for retrieving the document from a resource database; bandwidth use involved in retrieving the document from a resource database; and interference with other network traffic involved in retrieving the document from a resource database.

### TECHNICAL FIELD

The present invention relates to computer managed communication networks, such as the World Wide Web (Web), and, particularly, to the management and effective operation of Web source sites from which Web documents, such as Web pages and Web programs, are distributed in response to user requests. The invention is directed particularly to management of the document distribution caches at such Web source sites.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web related distribution of documents that may also include media. The convergence of the electronic entertainment and consumer industries with data processing exponentially accelerated the demand for wide ranging communication distribution channels and the Web or Internet, which had quietly existed for over a generation as a loose academic and government data distribution facility, reached “critical mass” and commenced a period of phenomenal expansion. With this expansion, businesses and consumers have direct access to all matter of documents including media. In addition, Hypertext Markup Language (HTML), which had been the documentation language of the Internet or Web for years, offered direct links between Web pages. This even further exploded the use of the Internet or Web.

Web documents are provided from a Web distribution site usually made up of one or more server computers that access the document from resource databases in response to a user request sent over the Web through a Web browser on the user's receiving Web station. Significant Web distribution sites are made up of many coordinated server computers and associated databases. Such significant Web distribution sites usually serve large institutions such as corporations, universities, retail stores or governmental agencies. These distribution sites may also provide to smaller businesses or organizations support for and distribution of individual Web pages created, owned and hosted by the individual small businesses and organizations.

Because of the complexity of Web distribution sites, it is costly and time consuming to access Web documents through the complexity of servers and databases at the Web distribution sites. Accordingly, it has long been the practice at such sites to maintain distribution site caches that temporarily store recently accessed Web documents at a forward distribution point with respect to the Web, so as to avoid the cost and time of reaccessing such documents from the databases.

Conventionally, the period of time that such cached Web documents have been stored in the cache has been dependent upon a variety of procedures for periodically clearing such caches. For example, each document may be stored in the cache for a user designated period of time. However, one type of widely used cache clearing procedure involves the recency of use of the documents in the cache, i.e. the recency of transmittal over the Web of the cached document with respect to the other cached documents. The clearing of documents from the caches referred to as “garbage collection” processes involves two conventional protocols: Most Recently Used (MRU) and Least Recently Used (LRU) Web documents being cleared during garbage collection.

### SUMMARY OF THE PRESENT INVENTION

We have noted that while protocols based upon recency of use of Web documents have, in the past, been relatively satisfactory in clearing of caches, the greatly accelerated use of the Web both in numbers of users and in the sizes of Web documents demands more effective processes for Web cache clearing. Accordingly, the present invention provides for the determining for each Web document in the cache, a retrieval hardship factor. Then, in the clearing of documents from the cache, this retrieval hardship factor will be used in combination with the above-described recency of use protocols in determining which documents are to be cleared from the cache. The retrieval hardship factor may be effectively used either in combination with either MRU or LRU cache garbage collection procedures.

The hardship retrieval factor is preferably determined for each accessed and cached Web document by the owner or host of the Web site, i.e. the resource location or source database on the Web. At least the following three attributes are used in this determination of the hardship retrieval factor: the total CPU time for retrieving the document from a resource database; bandwidth use involved in retrieving the document from a resource database; and interference with other network traffic involved in retrieving the document from a resource database.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of functioning as any of the server computers in the Web distribution or resource site or as a user interactive Web station for receiving Web pages;

FIG. 2 is a generalized diagrammatic view of a Web portion showing how the Web may be accessed from the Web stations for the requesting Web pages and the Web distribution or resource sites having caches in accordance with the present invention;

FIG. 3 is an illustrative example of the clearing of cached Web documents, i.e. garbage collection from a Web site cache using LRU collection procedures in accordance with the present invention in a combination of various levels of document retrieval hardship factors;

FIG. 4 is an illustrative flowchart describing the setting up of a Web distribution or resource site with a process for collecting garbage from distribution site caches based upon the combination of recency of use of documents and document retrieval hardship factors; and

FIG. 5 is a flowchart of an illustrative run of the program set up in FIG. 4.

### DETAILED DESCRIPTION OF THE PREFERRED EMBODIMENT

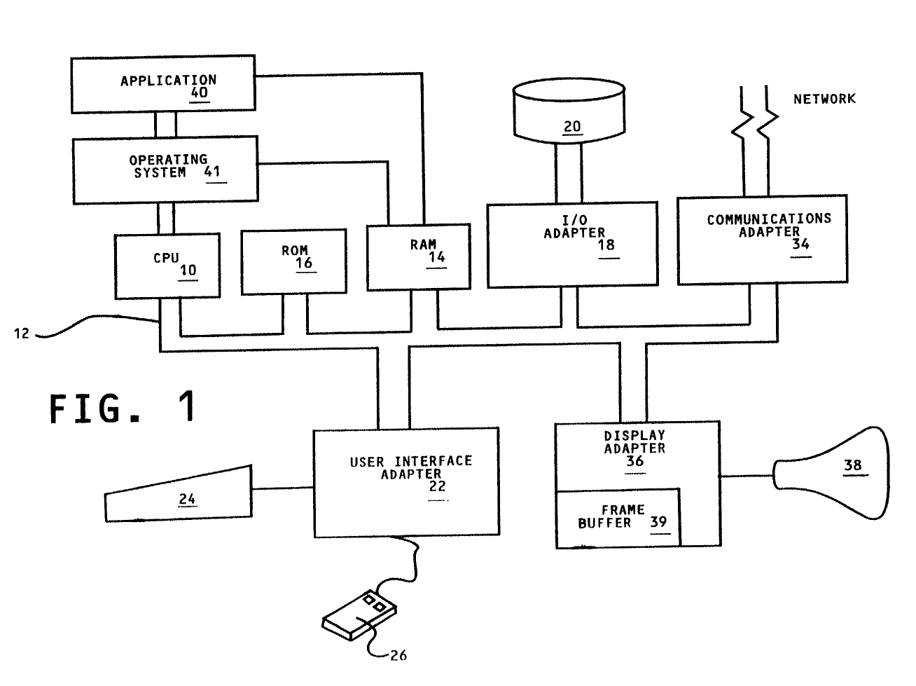

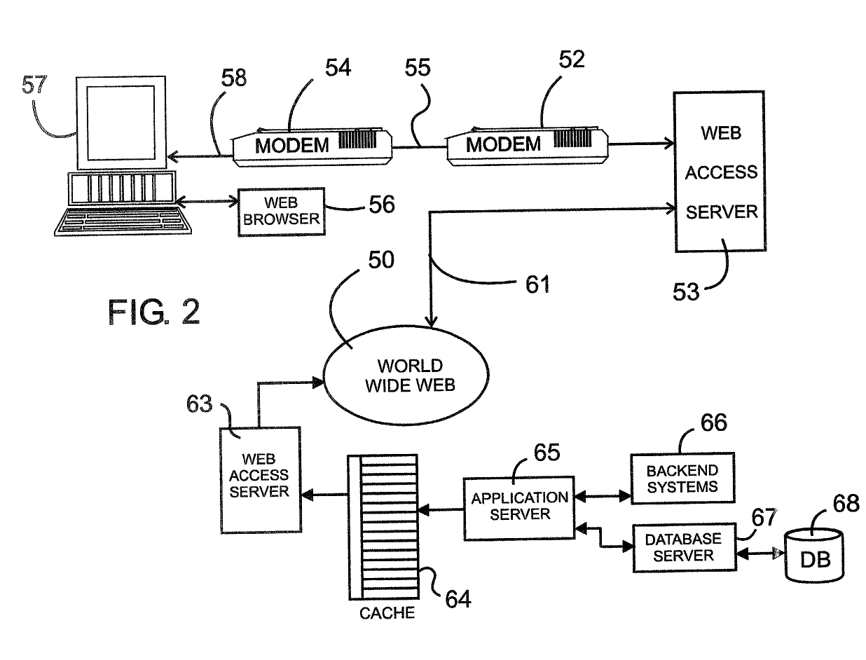

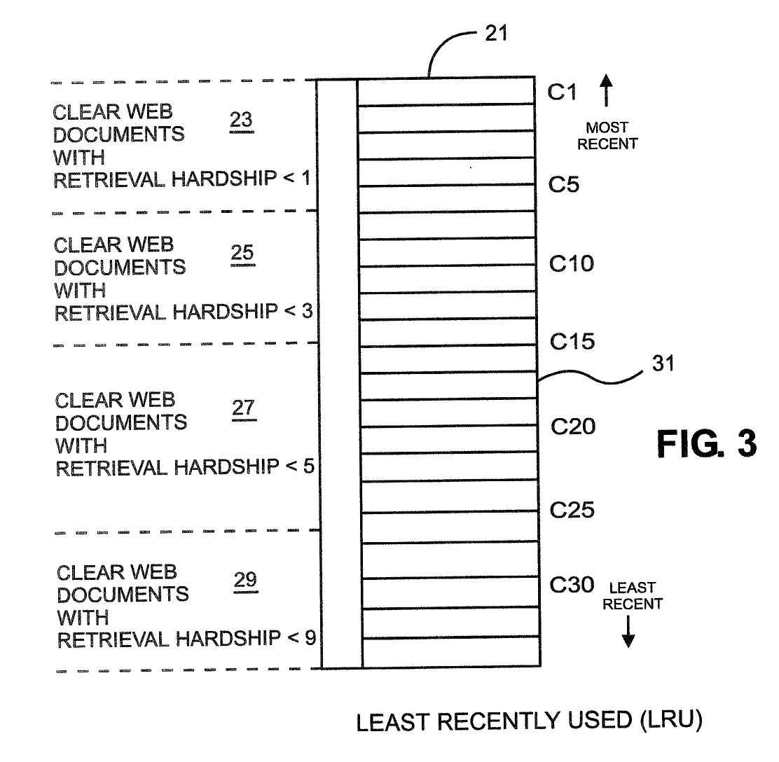

Referring to FIG. 1, a typical data processing system is shown that may function as the computer controlled network terminals or Web stations used conventionally as any of the receiving Web stations for requesting Web pages; the system shown is also illustrative of any of the server computers used in the Web distribution sites to be described in greater detail with respect to FIGS. 2 and 3.

A central processing unit (CPU) 10, may be one of the commercial microprocessors in personal computers available from International Business Machines Corporation (IBM) or other vendors, such as Sun Microsystems, Inc. When the system shown is used as a server computer at the Web distribution site to be subsequently described, then a workstation is preferably used, e.g. RISC System/6000™ (RS/6000) series available from IBM. The CPU is interconnected to various other components by system bus 12. An operating system 41 runs on CPU 10, provides control and is used to coordinate the function of the various components of FIG. 1. Operating system 41 may be one of the commercially available operating systems, such as IBM's AIX 6000™ operating system; as well as other IBM AIX and UNIX operating systems, or Microsoft's Windows2000™. Application programs 40, controlled by the system, are moved into and out of the main memory Random Access Memory (RAM) 14. These programs include the programs of the present invention for collecting garbage from distribution site caches based upon the combination of recency of use of documents and document retrieval hardship factors. Where the computer system shown functions as the receiving Web station, then any conventional Web browser application program, such as Microsoft's Internet Explorer™, will be available for accessing the Web pages from the Web to the receiving station. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 communicates with the disk storage device 20. Communications adapter 34 interconnects bus 12 with an outside network enabling the computer system to communicate with other such computers over a Local Area Network (LAN), e.g. the related server computers at the Web distribution site or through the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user at a receiving station may interactively relate to the Web in order to access Web documents. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods that may be related to the present invention. Since a major aspect of the present invention is directed to documents, such as Web pages, transmitted over networks, an understanding of networks and their operating principles would be helpful. We will not go into great detail in describing the networks to which the present invention is applicable. Reference has also been made to the applicability of the present invention to a global network, such as the Internet or Web. For details on Internet nodes, objects and links, reference is made to the text, Mastering the Internet, G. H. Cady et al., published by Sybex Inc., Alameda, Calif., 1996.

The Internet or Web is a global network of a heterogeneous mix of computer technologies and operating systems. Higher level objects are linked to the lower level objects in the hierarchy through a variety of network server computers. These network servers are the key to network distribution, such as the distribution of Web pages and related documentation. In this connection, the term “documents” is used to describe data transmitted over the Web or other networks and is intended to include Web pages with displayable text, graphics and other images. This displayable information may be still, in motion or animated, e.g. animated GIF images.

Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly at pp. 637-642, on HTML in the formation of Web pages. The images on the Web pages are implemented in a variety of image or graphic files such MPEG, JPEG or GIF files, which are described in the text, Internet: The Complete Reference, Millenium Edition, Young et al., 1999, Osborne/McGraw-Hill, particularly at pp. 728-730.

A generalized diagram of a portion of the Web for illustration of the Web distribution site of the present invention is shown in FIG. 2. The computer controlled display terminal 57 used for Web page receiving may be implemented by the computer system set up in FIG. 1, and connection 58 (FIG. 2) is the network connection shown in FIG. 1. For purposes of the present embodiment, computer 57 serves as a Web display station for receiving the Web documents requested via a Web browser program 56. Reference may be made to the above-mentioned Mastering the Internet, pp. 136-147, for typical connections between local display stations to the Web via network servers, any of which may be used to implement the system on which this invention is used.

The system embodiment of FIG. 2 has a host-dial connection. Such host-dial connections have been in use for over 30 years through network access servers 53 that are linked 61 to the Web 50. The servers 53 may be maintained by a service provider to the client's display terminal 57. The host's server 53 is accessed by the client terminal 57 through a normal dial-up telephone linkage 58 via modem 54, telephone line 55 and modem 52. The HTML file representative of the Web documents is downloaded to display terminal 57 through Web access server 53 via the telephone line linkages from server 53 that may have accessed them from the Internet 50 via linkage 61.

Of course, virtually thousands of Web document distribution sites or Web sites are the database resources available over the Web as the sources of the Web documents. In order to illustrate the cache clearing system of this invention, there is shown a simplified illustrative Web site that is accessed through Web server 63. There is the database 68 itself, served via database server 67, an application server 65, as well as the various backend systems 66 required to support the Web site. Dependent on the Web site size and it activities, there may be several databases at the site and several database servers. In any event, because of the advantages of caching accessed Web documents, the Web documents already accessed and sent are temporarily stored in a cache 64 that is preferably as far up front at the Web site as practical. It is with this system that the cache garbage collection of clearing procedures of the present invention will be applied.

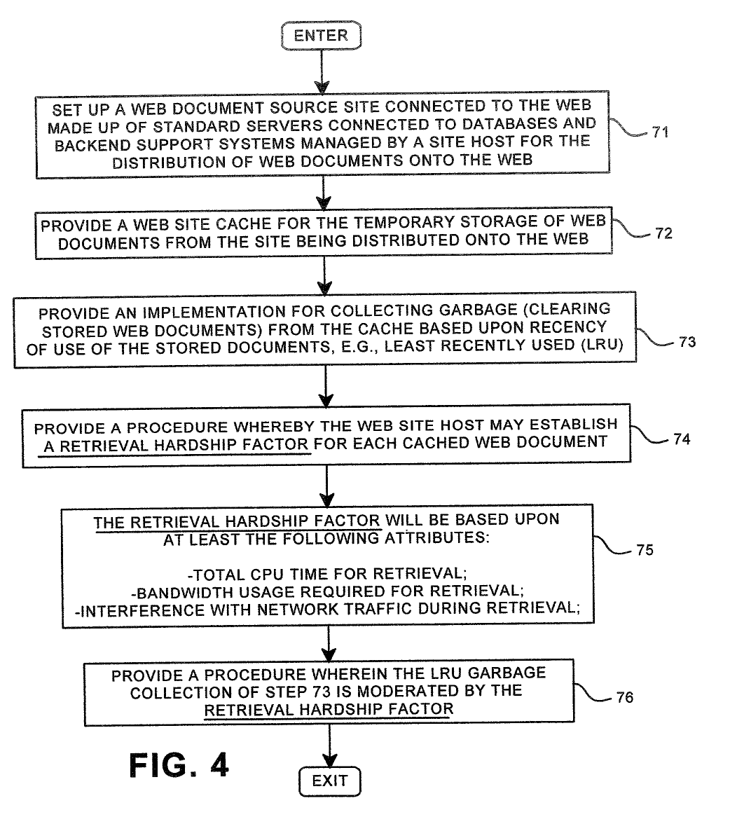

FIG. 4 is a flowchart showing the development of a process according to the present invention for collecting garbage from distribution site caches based upon the combination of recency of use of documents and document retrieval hardship factors. Step 71, a Web document distribution or source site, such as that shown in FIG. 2, is set up to access Web documents from a resource database. The site has standard servers connected to the database, as well as backend support systems managed by a site owner or host for the distribution of Web documents onto the Web. A Web site cache is provided for the temporary storage of Web documents accessed from the site for distribution onto the Web, step 72. There is provided an implementation for the collection of garbage, i.e. the clearing of stored Web documents from the cache based upon the recency of use of the stored documents, e.g. LRU for the purpose of this embodiment, step 73. A procedure is provided whereby the host for the site may establish a “retrieval hardship factor” for each cached Web document, step 74. We have noted that this retrieval hardship factor is preferably determined by the Web source site host or owner. He should be accorded some latitude in compiling the parameters or attributes that go into the factor and their relative weights in determining the factor since he should have the most familiarity with the hardship of retrieval of documents in his particular Web site database system. Some primary attributes that should be given most of the weight in determining this retrieval hardship factor are illustrated in step 75. The total CPU time for retrieval of the document, i.e. the total CPU tick time involved is determinable for each document. It will be dependent upon the size of the Web document and the complexity and depth of the database server system, e.g. the number of CPU's involved. The bandwidth usage required for the retrieval of the Web document from its original database is also determinable. As used here, it may be defined as the bandwidth capacity of the communications system between the database origin of the Web document and the cache position of the document that would be required to retrieve the document if the document were garbaged. Such bandwidth evaluation is discussed in the above-referenced Mastering the Internet, at page 60. The third attribute that may go into the determination of the hardship retrieval factor is the extent to which network traffic is interfered with during a retrieval of the Web document. This is an even less precise attribute than the first two. However, the owner or host of the Web site should be able to assign a value based on his knowledge and understanding of the dynamic or changing resources, client demands and needs of his Web site. For example, if traffic at his Web site is relatively slow, this factor could be given a relatively low value, i.e. low retrieval hardship factor component.

As a simple example of how this retrieval hardship factor may be determined, let us assume that the factor will be calculated to have a value of from zero to ten, with ten being the hardest to retrieve and zero being the easiest. Then: 1) the total CPU time could be allocated five units in this hardship factor with five being the hardest to retrieve; 2) the bandwidth usage could be allocated three units in this hardship factor with three being the hardest to retrieve; and 3) the interference with network traffic could be allocated two units in this hardship factor with two being the hardest to retrieve. In this manner, a total retrieval hardship factor of from zero to ten could be determined for each Web document in the cache.

Finally, step 76, a procedure is established wherein the LRU garbage collection is moderated by the retrieval hardship factor. FIG. 3 provides a simplified illustrative example of such a procedure. Cache 21 has over 30 positions at which documents may be stored, e.g. C1 past C30. A Web document is stored at each slot. While the slots are shown as uniform in size for convenience in illustration, it is understood that the stored Web documents at each slot may vary greatly in size. Since, the procedure being illustrated is a LRU procedure, then, in conventional practice, the most recently accessed Web document from the cache or from the appropriate database would be placed at the top of the cache and would then be progressively pushed down the cache as new subsequent Web documents were accessed (unless of course, the Web documents were accessed again) until the LRU Web documents were pushed down to the bottom of the cache. Garbage collection was conventionally done from the cache bottom so that a number of LRU documents were periodically cleared from the bottom.

With the present invention, the garbage collection is moderated as follows in FIG. 3. A Retrieval Hardship Factor is determined for each cached document, as previously described. This hardship factor will have a value of from zero to ten for each document. Then, during clearance of the cache, instead of eliminating a group of Web documents from the cache bottom, documents are eliminated from all levels of the cache as shown. At Level 23 near the top of the cache, all Web documents having a Retrieval Hardship Factor of less than one are eliminated, since these documents should be relatively easy to retrieve. Further down, at Level 25, all Web documents having a Retrieval Hardship Factor of less than three are eliminated, since these documents are somewhat harder to retrieve. Then, even further down, at Level 27, all Web documents having a Retrieval Hardship Factor of less than five are eliminated, since these documents are even harder to retrieve. Finally, at Level 29, near the bottom of the cache, only documents with a Retrieval Hardship Factor of less than nine are eliminated. Thus, it may be seen that documents with Retrieval Hardship Factors between 9 and 10 may never be eliminated from the cache because they are so hard to retrieve.

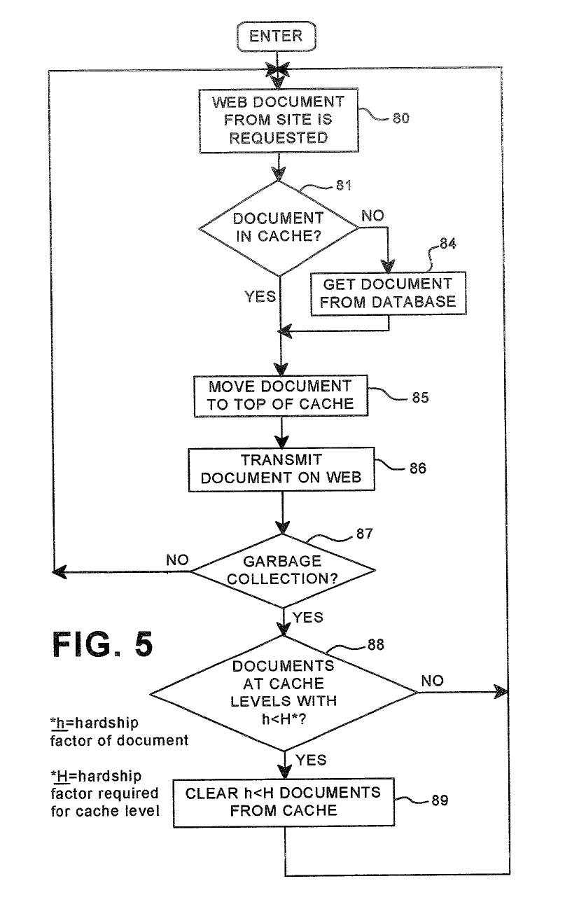

A simplified run of the process set up in FIG. 4 and described in connection with FIG. 3 will now be described with respect to the flowchart of FIG. 5. First, we are going to assume that, step 80, a Web document from a Web source site having the cache process of the present invention has been requested. A determination is first made as to whether the document is already in the cache, step 81. If Yes, the document is moved to the top of the cache, step 85; if No, the document is retrieved from the database, step 84, and then moved to the top of the cache, step 85. The document is then transmitted onto the Web to the eventual requester, step 86. Periodically, step 87, a determination is made as to whether it is time for garbage collection. If No, the procedure is returned to step 80 where the next Web document request from the site is handled. If Yes, we are at the next garbage collection cycle, then, step 88, a determination is made, using the cache clearing protocols described in FIG. 3, as to whether there are Web documents cached at the various cache levels with: h>H, where h is the retrieval hardship factor of the Web document and H is the retrieval hardship factor required for the level at which the respective Web document is cached. If No, the procedure is returned to step 80 where the next Web document request from the site is handled. If Yes, then all Web documents with h>H are cleared from the cache, step 89, and the procedure is returned to step 80 where the next Web document request from the site is handled.

One of the preferred implementations of the present invention is in application program 40 made up of programming steps or instructions resident in RAM 14, FIG. 1, of Web server computers during various Web operations. Until required by the computer system, the program instructions may be stored in another readable medium, e.g. in disk drive 20, or in a removable memory such as an optical disk for use in a CD ROM computer input, or in a floppy disk for use in a floppy disk drive computer input. Further, the program instructions may be stored in the memory of another computer prior to use in the system of the present invention and transmitted over a LAN or a Wide Area Network (WAN), such as the Internet, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a World Wide Web (Web) communication network with user access via a plurality of data processor controlled interactive receiving display stations for displaying Web documents transmitted to said receiving display stations from resource locations remote from said stations, a Web server system for accessing said Web documents from resource databases and transmitting said Web documents onto said Web comprising:
a cache for temporarily storing a plurality of accessed Web documents;
means for determining for each of said individual documents in said cache, a retrieval hardship factor; and
means for clearing selected stored individual documents from said cache based upon recency of use of said documents and said retrieval hardship factor.

2. The Web system of claim 1 wherein said recency of use of said cache documents is based on most recently used (MRU) documents.

3. The Web system of claim 1 wherein said recency of use of said cache documents is based on least recently used (LRU) documents.

4. The Web system of claim 1 further having means for determining said retrieval hardship factor for each cache document including the attribute of the total CPU time for retrieving the document from a resource database.

5. The Web system of claim 4 wherein said means for determining said retrieval hardship factor for each cache document further includes the attribute of bandwidth use involved in retrieving the document from a resource database.

6. The Web system of claim 5 wherein said means for determining said retrieval hardship factor for each cache document further includes the attribute of interference with other network traffic involved in retrieving the document from a resource database.

7. The Web system of claim 1 wherein said means for clearing selected stored individual documents includes:
means for establishing levels of recency of use; and
means for clearing all documents at each level of recency of use failing to have a retrieval hardship factor respectively selected for each of said levels of recency of use.

8. In a Web communication network with user access via a plurality of data processor controlled interactive receiving display stations for displaying Web documents transmitted to said receiving display stations from resource locations remote from said stations, and a Web server system for accessing said Web documents from resource databases and transmitting said Web documents onto said Web, a method for temporarily caching a plurality of accessed Web documents comprising:
determining for each of said individual documents in said cache, a retrieval hardship factor; and
clearing selected stored individual documents from said cache based upon recency of use of said documents and said retrieval hardship factor.

9. The method of claim 8 wherein said recency of use of said cached documents is based on most recently used (MRU) documents.

10. The method of claim 8 wherein said recency of use of said cached documents is based on least recently used (LRU) documents.

11. The method of claim 8 wherein the step of determining said retrieval hardship factor for each cache document uses the attribute of the total CPU time for retrieving the document from a resource database.

12. The method of claim 11 wherein the step of determining said retrieval hardship factor for each cache document further uses the attribute of bandwidth use involved in retrieving the document from a resource database.

13. The method of claim 12 wherein the step of determining said retrieval hardship factor for each cache document further uses the attribute of interference with other network traffic involved in retrieving the document from a resource database.

14. The method of claim 8 wherein the step of clearing selected stored individual documents includes:
establishing levels of recency of use of documents; and
clearing all documents at each level of recency of use failing to have a retrieval hardship factor respectively selected for each of said levels of recency of use.

15. A computer program having code recorded on a computer readable medium for accessing Web documents from resource databases and transmitting said Web documents onto the Web communication network with user access via a plurality of data processor controlled interactive receiving display stations for displaying Web documents transmitted to said receiving display stations from resource locations remote from said stations, and a Web server system for accessing said Web documents from said resource databases and transmitting said Web documents onto said Web, said program comprising:
a cache for temporarily storing a plurality of accessed Web documents;
means for determining for each of said individual documents in said cache, a retrieval hardship factor; and
means for clearing selected stored individual documents from said cache based upon recency of use of said documents and said retrieval hardship factor.

16. The computer program of claim 15 wherein said recency of use of said cache documents is based on most recently used (MRU) documents.

17. The computer program of claim 15 wherein said recency of use of said cache documents is based on least recently used (LRU) documents.

18. The computer program of claim 15 further having means for determining said retrieval hardship factor for each cache document including the attribute of the total CPU time for retrieving the document from a resource database.

19. The computer program of claim 18 wherein said means for determining said retrieval hardship factor for each cache document further includes the attribute of bandwidth use involved in retrieving the document from a resource database.

20. The computer program of claim 19 wherein said means for determining said retrieval hardship factor for each cache document further includes the attribute of interference with other network traffic involved in retrieving the document from a resource database.

21. The computer program of claim 15 wherein said means for clearing selected stored individual documents includes:
means for establishing levels of recency of use; and
means for clearing all documents at each level of recency of use failing to have a retrieval hardship factor respectively selected for each of said levels of recency of use.

22. In a computer managed communication network with user access via a plurality of data processor controlled receiving stations for displaying network documents transmitted to said receiving display stations from resource locations remote from said stations, a network server system for accessing said network documents from resource databases and transmitting said documents onto said network comprising:
a cache for temporarily storing a plurality of accessed network documents;
means for determining for each of said individual documents in said cache, a retrieval hardship factor; and
means for clearing selected stored individual documents from said cache based upon recency of use of said documents and said retrieval hardship factor.

23. In a computer managed communication network with user access via a plurality of data processor controlled interactive receiving display stations for displaying network documents transmitted to said receiving display stations from resource locations remote from said stations, and a network server system for accessing said network documents from resource databases and transmitting said documents onto said network, a method for temporarily caching a plurality of accessed network documents comprising:
determining for each of said individual documents in said cache, a retrieval hardship factor; and
clearing selected stored individual documents from said cache based upon recency of use of said documents and said retrieval hardship factor.

24. A computer program having code recorded on a computer readable medium for accessing network documents from resource databases and transmitting said network documents onto a communication network with user access via a plurality of data processor controlled interactive receiving display stations for displaying network documents transmitted to said receiving display stations from resource locations remote from said stations, and a network server system for accessing said documents from said resource databases and transmitting said documents onto said communication network, said program comprising:
a cache for temporarily storing a plurality of accessed network documents;
means for determining for each of said individual documents in said cache, a retrieval hardship factor; and
means for clearing selected stored individual documents from said cache based upon recency of use of said documents and said retrieval hardship factor.
